(19) United States
(12) Patent Application Publication
(10) Pub. No.: US 2016/0349983 A1
(43) Pub. Date: Dec. 1, 2016

(54) TERMINAL SCREEN SHOT METHOD AND TERMINAL

(71) Applicant: GIONEE COMMUNICATION EQUIPMENT CO., LTD. SHENZHEN, Shenzhen (CN)

(72) Inventor: Yanmin JIN, Shenzhen (CN)

(73) Assignee: GIONEE COMMUNICATION EQUIPMENT CO.,LTD. SHENZHEN, Shenzhen, GD (CN)

(21) Appl. No.: 15/023,499

(22) PCT Filed: Aug. 7, 2014
(86) PCT No.: PCT/CN2014/083854

§ 371 Date: Mar. 21, 2016

(30) Foreign Application Priority Data
Jan. 24, 2014 (CN) 201410033962.7

(51) Int. Cl. G06F 3/0488; G06F 3/041; G06F 3/0484; G06T 1/00

(52) U.S. Cl. CPC G06F 3/04883; G06T 1/0007; G06F 3/0416; G06F 3/04845; G06F 2203/04808

(57) ABSTRACT

Embodiments of the present invention disclose a method for capturing a screen of a terminal. The method includes: obtaining a screen capture instruction for capturing a terminal interface input by a user, detecting actions of at least two objects touching or approaching a touchscreen and obtaining corresponding operation points on the touchscreen according to the detected actions, determining an area to capture in the terminal interface according to the operation points, and storing the image corresponding to the area to capture as a screenshot. Accordingly, embodiments of the present invention further discloses a terminal. By means of embodiments of the present invention, a screenshot needed by the user can be obtained according to operations performed by the user on the touchscreen, thereby improving user's experience.

### FIELD OF THE TECHNICAL

The present disclosure relates to image manipulation technology field, and particularly relates to a method for capturing a screen of a terminal and a terminal.

### BACKGROUND

The existing method for capturing a screen of a terminal can capture a whole terminal interface to obtain a screenshot. However, the screenshot obtained by the method for capturing a screen may include information not needed by a user. After the user edits the screenshot again, a needed image can be obtained. Therefore, the operation for the method for capturing a screen is complicated, thereby decreasing user's experience.

### SUMMARY

The embodiments of the present invention provide a method for capturing a screen of a terminal and a terminal. By means of the embodiments of the present invention, a screenshot needed by the user can be obtained according to operation performed by a user on a touchscreen, thereby improving user's experience.

The embodiments of the present invention provides a method for capturing a screen which includes the following.

Obtaining a screen capture instruction for capturing a terminal interface input by a user.

Detecting actions of at least two objects touching or approaching a touchscreen and obtaining corresponding operation points on the touchscreen according to the detected actions.

Determining an area to capture in the terminal interface according to the operation points.

Storing the image corresponding to the area to capture as a screenshot.

Accordingly, the embodiments of the present invention also provides a terminal which includes the following.

A screen capture instruction obtaining unit is configured to obtain a screen capture instruction for capturing a terminal interface input by a user.

An operation point obtaining unit is configured to detect actions of at least two objects touching or approaching a touchscreen and obtain corresponding operation points on the touchscreen according to the detected actions.

An area to capture determining unit is configured to determine an area to capture in the terminal interface according to the operation points obtained by the operation point obtaining unit.

A screenshot obtaining unit is configured to store the image corresponding to the area to capture determined by the area to capture determining unit as a screenshot.

Accordingly, the embodiments of the present invention also provides a terminal. The terminal includes a user interface, a memory, and a processor. Wherein, the memory stores a set of program code. The processor is configured to invoke the program code stored in the memory to execute the following operations.

An operation is to obtain a screen capture instruction for capturing a terminal interface input by a user.

An operation is to detect actions of at least two objects touching or approaching a touchscreen and obtain corresponding operation points on the touchscreen according to the detected actions.

An operation is to determine an area to capture in the terminal interface according to the operation points.

An operation is to store the image corresponding to the area to capture as a screenshot.

The embodiments of the present invention can determine an area to capture in the terminal interface according to actions of at least two objects touching or approaching the touchscreen, and store the image corresponding to the area to capture as a screenshot, thus a screenshot needed by the user can be obtained according to operations performed by the user on the touchscreen, thereby improving user's experience.

### BRIEF DESCRIPTION OF THE DRAWINGS

To better illustrate the technical solution of embodiments of the present invention, the following descriptions will briefly illustrate the accompanying drawings described in the embodiments. Obviously, the following described accompanying drawings are some embodiments of the present invention. Those skilled in the art can obtain other accompanying drawings according to the described accompanying drawings without creative work.

FIG. 1 is a flow chart of a method for capturing a screen of a terminal in accordance with an exemplary embodiment of the present invention.

FIG. 2 is a schematic view showing a determined area to capture in accordance with an exemplary embodiment of the present invention.

FIG. 3 is a schematic view showing a determined area to capture in accordance with another exemplary embodiment of the present invention.

FIG. 4 is a schematic view showing performing operations on the determined area to capture in accordance with an exemplary embodiment of the present invention.

FIG. 5 is a flow chart of a method for capturing a screen of a terminal in accordance with another exemplary embodiment of the present invention.

FIG. 6 is a schematic view of a structure of a terminal in accordance with an exemplary embodiment of the present invention.

FIG. 7 is a schematic view of a structure of an operation point obtaining unit in accordance with an exemplary embodiment of the present invention.

FIG. 8 is a schematic view of a structure of an area to capture determining unit in accordance with an exemplary embodiment of the present invention.

FIG. 9 is a schematic view of a structure of a terminal in accordance with another exemplary embodiment of the present invention.

### DETAILED DESCRIPTION OF ILLUSTRATED EMBODIMENTS

The technical solution of embodiments of the present invention will be described clearly and completely in combination with the accompanying drawings of the embodiments of the present invention. Obviously, the described embodiments are a part of embodiments of the present invention, and not all of the embodiments. According to the embodiments of the present invention, other embodiments obtained by those skilled in the art without creative work all fall within the protection scope of the present invention.

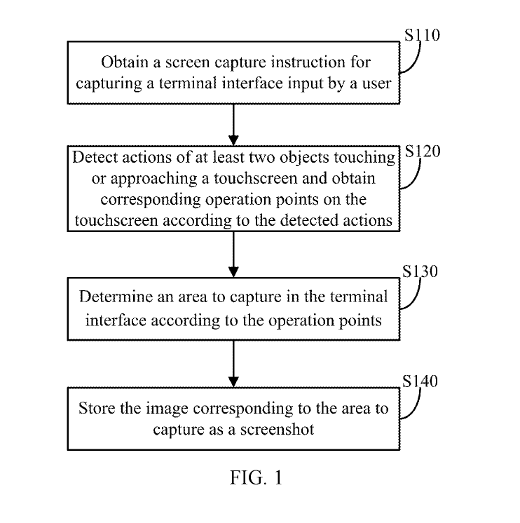

Referring to FIG. 1, FIG. 1 is a flow chart of a method for capturing a screen of a terminal in accordance with an exemplary embodiment of the present invention. The method for capturing a screen of a terminal provided by an exemplary embodiment of the present invention can be applied to terminals having a touchscreen, such as mobile phones, PADs, laptop computers, personal computers, and so on. As shown in FIG. 1, the method for capturing a screen of a terminal in this embodiment may include the following.

In step S110, obtaining a screen capture instruction for capturing a terminal interface input by a user.

Specifically, the terminal can obtain the screen capture instruction for capturing the terminal interface input by the user, and the screen capture instruction triggers the terminal to detect actions of at least two objects touching or approaching a touchscreen.

As used for an optional embodiment, the user can perform a long press on the terminal interface, so as to cause the terminal to obtain the screen capture instruction for capturing the terminal interface input by the user. The user can also perform continuous clicks on the terminal interface, so as to cause the terminal to obtain the screen capture instruction for capturing the terminal interface input by the user. In other embodiments, other optional triggering methods can be used to cause the terminal to obtain the screen capture instruction for capturing the terminal interface input by the user. For example, one other triggering method can be the method of comparing a sliding track input by the user performing a sliding operation on the terminal interface with a preset sliding track, and so on. Other realization methods extended from the above methods all fall within the scope of the present invention.

In step S120, detecting actions of at least two objects touching or approaching the touchscreen and obtaining corresponding operation points on the touchscreen according to the detected actions.

The operation coordinates of each operation point on the touchscreen may include a horizontal coordinate and a vertical coordinate. Wherein, the horizontal coordinate of the operation coordinates of each operation point can be determined according to a distance between the mapping point of each operation point on the horizontal axis and the mapping point of a reference point on the horizontal axis and the horizontal coordinate of the reference point. The vertical coordinate of the operation coordinates of each operation point can be determined according to a distance between the mapping point of each operation point on the vertical axis and the mapping point of the reference point on the vertical axis and the vertical coordinate of the reference point. The reference point can be any preset point of the touchscreen.

Specifically, the touchscreen can be a capacitive screen, a resistive screen, a surface acoustic wave screen, and so on. The terminal can detect parameter values of the touchscreen (e.g., current value, acoustic energy value, and so on). If the detected parameter value is greater than a preset threshold, the terminal determines that there is one object approaching the touchscreen, and then determines the corresponding operation point according to the corresponding action. For example, if the touchscreen is a capacitive screen, when the user moves one finger to approach the touchscreen, the current through the corresponding position of the touchscreen changes. When the terminal determines that the current value reaches the preset threshold, the terminal determines that there is one object approaching the touchscreen. When the terminal obtains the screen capture instruction for capturing the terminal interface input by the user, the terminal can detect the number of the objects touching or approaching the touchscreen (e.g., mobile phone or stylus). If the terminal detects that there are at least two objects touching or approaching the touchscreen, the terminal obtains the corresponding operation points according to the actions of all the detected objects performed on the touchscreen, and determines an area to capture according to the obtained operation points.

As used for an optional embodiment, the terminal can determine the touch or approach action of at least one of the at least two objects performed on the touchscreen, and obtain corresponding operation points on the touchscreen according to the final position of the at least one object at the end of the touch or approach action. Specifically, when there are at least two objects touching or approaching the touchscreen, the terminal can obtain the corresponding operation point of each object according to the position of each object on the touchscreen. The user can change the position of at least one of the at least two objects on the touchscreen. The terminal can obtain an end operation point on the touchscreen according to the final position of the at least one object at the end of the touch or approach action. The terminal can determine an area to capture according to the end operation points. For example, if the user touches the touchscreen by two fingers, the terminal can determine corresponding operation points according to the positions of the two fingers on the touchscreen. The user can move at least one finger of the two fingers, thereby change the corresponding operation point. The terminal can obtain corresponding end operation points according to the final positions of the two fingers on the touchscreen, and determines an area to capture according to the obtained end operation points.

Furthermore and optionally, the user can change the number of the objects touching or approaching the touchscreen. The terminal can obtain the corresponding operation positions according to the number of the finally detected objects and the position of each object on the terminal interface. For example, at first, the user uses two fingers to capture the terminal interface. During the process of capturing the terminal interface, another finger is further used by the user to capture the terminal interface. The terminal can obtain the corresponding operation points according to positions of the three fingers on the touchscreen. Wherein, the terminal can display the operation points in real-time, and the displayed operation points can be changed according to the change of the positions of the corresponding objects on the touchscreen. The terminal can determine an area to capture according to end operation points.

In step S130, determining an area to capture in the terminal interface according to the operation points.

Specifically, the terminal can determine an area to capture in the terminal interface according to the operation points.

As used for an optional embodiment, if the terminal obtains two operation points on the touchscreen, the terminal can determine an area to capture according to a circle formed by the two operation points. For example, the terminal can determine a straight line according to the two operation points, and determines a circle one symmetry axis of which is the straight line as an area to capture. For another example, the terminal can form a circle area the center of which is any of the two operation points and one circumferential point of which is another operation point, and determine the circle area as an area to capture.

The terminal can further determine an elliptical area formed by the two operation points as an area to capture. For example, the terminal can determine the two operation points as two ellipse focuses, and determine an elliptical area formed by the two ellipse focuses as an area to capture. In other embodiments, other optional methods of determining an elliptical area according to two operation points can be used. For example, the method of determining an elliptical area vertexes of a long axis of which are the two operation points and the length of a short axis of which equals to a preset length can be used. Other realization methods obtained based on the above methods all fall within the scope of the present invention.

The terminal can also determine a rectangular area formed by the two operation points as an area to capture. For example, the terminal can determine a rectangular area the diagonal line of which is the connection line formed by the two operation points as an area to capture.

It needs to point out that in other embodiments other methods of determining a circle, an ellipse, or a rectangle according to two operation points can be used. Other realization methods obtained based on the above methods all fall within the scope of the present invention.

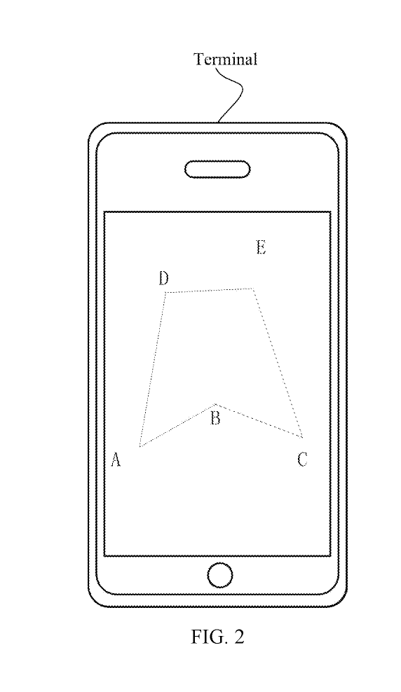

As used for an optional embodiment, if the terminal obtains at least three operation points of the touchscreen, the terminal determines a polygon area vertexes of which are respectively the at least three operation points and edges of which are respectively the connection lines each formed by two adjacent operation points of the at least three operation points as an area to capture. For example, if the terminal obtains five operation points on the touchscreen, e.g., the operation points of A, B, C, D, and E shown in FIG. 2, the terminal determines a polygon area vertexes of which are respectively the operations points of A, B, C, D, and E and edges of which are respectively the connection lines of AB, BC, CE, ED, and DA as an area to capture. As shown in FIG. 2, wherein, each of the operation points of A, B, C, D, and E has its own coordinate information with respect to the screen. In actual use, the terminal can display the operation points on the touchscreen.

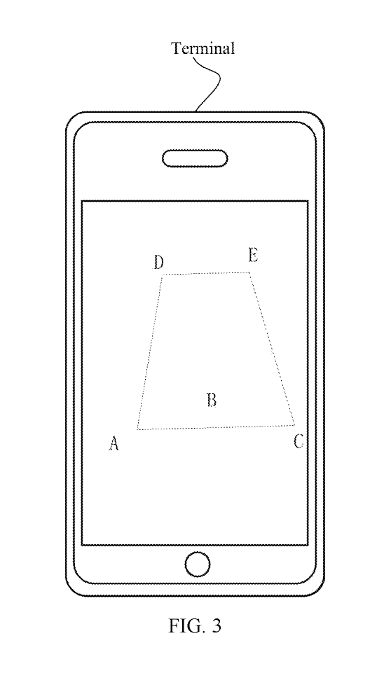

As used for an operational embodiment, if the terminal obtains at least three operation points on the touchscreen, the terminal can determine a greatest operation area formed by the connection of the at least three operation points as an area to capture. That is, the terminal does not need to determine each operation point as a vertex, and what is needed to do is to determine a greatest operation area formed by at least two operation points of the at least three operation points as an area to capture. For example, for the five operation points of A, B, C, D, and E shown in FIG. 2, the terminal can form a greatest operation area by connecting A to C, connecting C to E, connecting E to D, and connecting A to D, and determine the greatest operation area as an area to capture shown in FIG. 3.

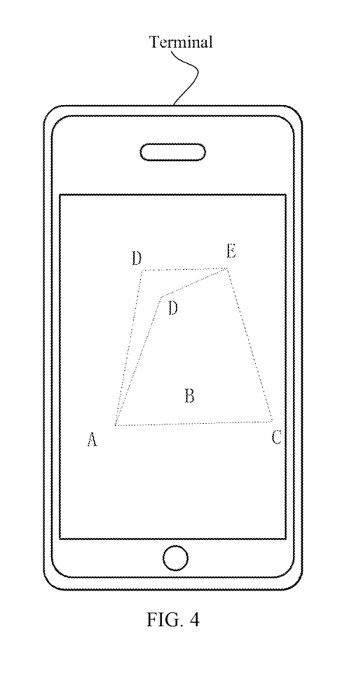

Furthermore and optionally, after the terminal determines the area to capture in the terminal interface according to the operation points, the terminal can adjust the area to capture according to operations performed by the user on the obtained operation points. Specifically, after the terminal determines an area to capture in the terminal interface, the terminal can correspondingly adjust the area to capture according to operations performed by the user on any of or more of the operation points. For example, the area to capture determined by the terminal is shown in FIG. 3, and the user has performed an operation on the operation point of D. The adjusted figure is shown in FIG. 4. Wherein, in FIG. 4 the figure formed by solid lines is the adjusted figure.

Furthermore and optionally, the user can change the position of the area to capture in the terminal interface by approaching or touching any position of the area to capture.

In step S140, storing the image corresponding to the area to capture as a screenshot.

Specifically, the terminal can store the content displayed in the terminal interface and corresponding to the area to capture as a screenshot.

The embodiments of the present invention can determine an area to capture in the terminal interface according to actions of at least two objects touching or approaching the touchscreen, and store the image corresponding to the area to capture as a screenshot, thus a screenshot needed by the user can be obtained according to operations performed by the user on the touchscreen, thereby improving user's experience.

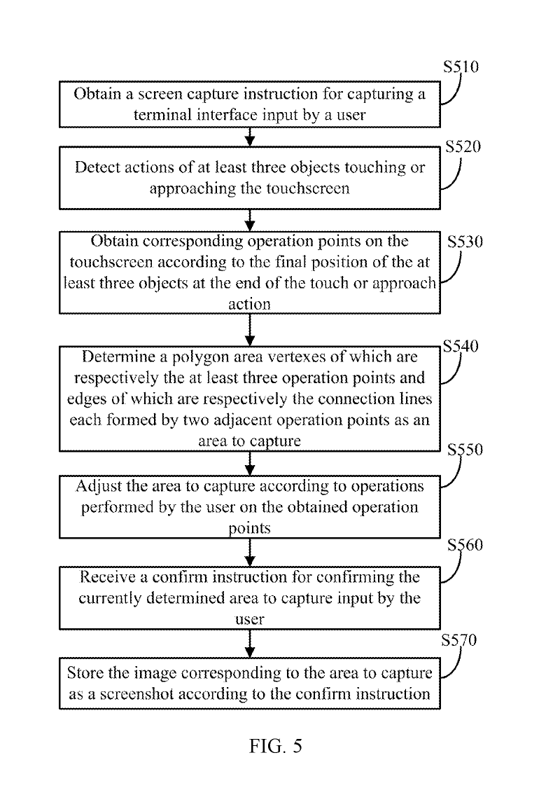

Referring to FIG. 5, FIG. 5 is a flow chart of a method for capturing a screen of a terminal in accordance with another exemplary embodiment of the present invention. The method for capturing a screen of a terminal provided by an exemplary embodiment of the present invention can be applied to terminals having a touchscreen, such as mobile phones, PADs, laptop computers, personal computers, and so on. As shown in FIG. 5, the method for capturing a screen of a terminal in this embodiment may include the following.

In step S510, obtaining a screen capture instruction for capturing a terminal interface input by a user.

Specifically, the terminal can obtain the screen capture instruction for capturing the terminal interface input by the user, and the screen capture instruction triggers the terminal to detect actions of at least two objects touching or approaching a touchscreen.

As used for an optional embodiment, the user can perform a long press on the terminal interface, so as to cause the terminal to obtain the screen capture instruction for capturing the terminal interface input by the user. The user can also perform continuous clicks on the terminal interface, so as to cause the terminal to obtain the screen capture instruction for capturing the terminal interface input by the user. In other embodiments, other optional triggering methods can be used to cause the terminal to obtain the screen capture instruction for capturing the terminal interface input by the user. For example, one other triggering method can be the method of comparing a sliding track input by the user performing a sliding operation on the terminal interface with a preset sliding track, and so on. Other realization methods obtained based on the above methods all fall within the scope of the present invention.

In step S520, detecting actions of at least three objects touching or approaching the touchscreen.

Specifically, the touchscreen can be a capacitive screen, a resistive screen, a surface acoustic wave screen, and so on. The terminal can detect parameter values of the touchscreen (e.g., current value, acoustic energy value, and so on). If the detected parameter value is greater than a preset threshold, the terminal determines that there is one object approaching the touchscreen, and then determines the corresponding operation point according to the corresponding action. For example, if the touchscreen is a capacitive screen, when the user moves one finger to approach the touchscreen, the current through the corresponding position of the touchscreen changes. When the terminal determines that the current value reaches the preset threshold, the terminal determines that there is one object approaching the touchscreen. When the terminal obtains the screen capture instruction for capturing the terminal interface input by the user, the terminal can detect the number of the objects touching or approaching the touchscreen (e.g., mobile phone or stylus). If the terminal detects that there are at least three objects touching or approaching the touchscreen, the terminal can detect an action of at least one object of the at least three objects performed on the touchscreen.

In step S530, obtaining corresponding operation points on the touchscreen according to the final position of the at least three objects at the end of the touch or approach action.

Specifically, the terminal can obtain corresponding operation points according to the position of each of the at least three finally detected objects on the touchscreen. In other embodiments, the terminal can obtain and display the corresponding operation points according to the position of each of the at least three objects on the touchscreen.

As used for an optional embodiment, the user can change the number of the objects touching or approaching the touchscreen. The terminal can obtain the corresponding operation positions according to the number of the finally detected objects and the position of each object on the terminal interface. For example, at first, the user uses three fingers to capture the terminal interface. During the process of capturing the terminal interface, another finger is further used by the user to capture the terminal interface. The terminal can obtain the corresponding operation points according to positions of the four fingers on the touchscreen.

In step S540, determining a polygon area vertexes of which are respectively the at least three operation points and edges of which are respectively the connection lines each formed by two adjacent operation points of the at least three operation points as an area to capture.

Specifically, the terminal can determine a polygon area vertexes of which are respectively the at least three operation points and edges of which are respectively the connection lines each formed by two adjacent operation points of the at least three operation points as an area to capture. For example, if the terminal obtains five operation points on the touchscreen, e.g., the operation points of A, B, C, D, and E shown in FIG. 2, the terminal determines a polygon area vertexes of which are respectively the operations points of A, B, C, D, and E and edges of which are respectively the connection lines of AB, BC, CE, ED, and DA as an area to capture. As shown in FIG. 2, wherein, each of the operation points of A, B, C, D, and E has its own coordinate information with respect to the screen. In actual use, the terminal can display the operation points on the touchscreen. In other optional embodiments, the terminal can determine an operation area formed according to other optional ways. For example, the terminal can determine a greatest operation area formed by the connection of the at least three operation points as an area to capture.

In step S550, adjusting the area to capture according to operations performed by the user on the obtained operation points.

Specifically, after the terminal determines the area to capture in the terminal interface, the terminal can correspondingly adjust the area to capture according to operations performed by the user on any of or more of the operation points. For example, the area to capture determined by the terminal is shown in FIG. 3, and the user has performed an operation on the operation point of D. The adjusted figure is shown in FIG. 4. Wherein, in FIG. 4 the figure formed by solid lines is the adjusted figure.

It needs to point out that in other optional embodiments, after the terminal executes step S540, the terminal directly executes step S560.

In step S560, receiving a confirm instruction for confirming the currently determined area to capture input by the user.

Specifically, after the terminal determines the adjusted area to capture, the terminal prompts the user whether or not to confirm the currently adjusted area to capture. After receiving a confirm instruction for confirming the currently determined area to capture input by the user, step S570 is executed.

In step S570, storing the image corresponding to the area to capture as a screenshot according to the confirm instruction.

Specifically, the terminal can store the content displayed in the terminal interface and corresponding to the area to capture as a screenshot according to the confirm instruction.

The embodiments of the present invention can determine an area to capture in the terminal interface according to actions of at least three objects touching or approaching the touchscreen, and store the image corresponding to the area to capture as a screenshot, thus a screenshot needed by the user can be obtained according to operations performed by the user on the touchscreen, thereby improving user's experience.

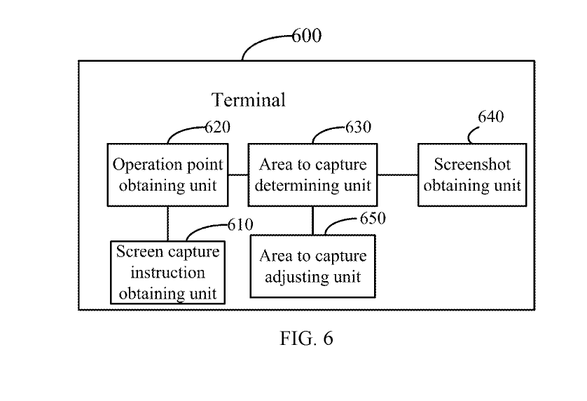

Referring to FIG. 6, FIG. 6 is a schematic view of a structure of a terminal in accordance with an exemplary embodiment of the present invention. The terminal provided by an exemplary embodiment of the present invention can be applied to terminals having a touchscreen, such as mobile phones, PADs, laptop computers, personal computers, and so on. As shown in FIG. 6, the terminal in this embodiment of the preset invention may at least include a screen capture instruction obtaining unit 610, an operation point obtaining unit 620, an area to capture determining unit 630, and a screenshot obtaining unit 640.

The screen capturing instruction obtaining unit 610 is configured to obtain a screen capture instruction for capturing a terminal interface input by a user.

Specifically, the screen capturing obtaining unit 610 can obtain the screen capture instruction for capturing the terminal interface input by the user, and the screen capture instruction triggers the operation point obtaining unit 620 to detect actions of at least two objects touching or approaching a touchscreen.

Optionally, the user can perform a long press on the terminal interface, so as to cause the screen capture instruction obtaining unit 610 to obtain the screen capture instruction for capturing the terminal interface input by the user. The user can also perform a continuous click on the terminal interface, so as to cause the screen capture instruction obtaining unit 610 to obtain the screen capture instruction for capturing the terminal interface input by the user.

The operation point obtaining unit 620 is configured to detect actions of at least two objects touching or approaching the touchscreen, and obtain corresponding operation points on the touchscreen according to the detected actions.

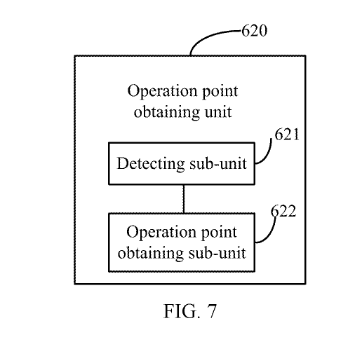

Optionally, as shown in FIG. 7, the operation point obtaining unit 620 can further include a detecting sub-unit 621 and an operation point obtaining sub-unit 622.

The detecting sub-unit 621 is configured to determine the touch or approach action of at least one of the at least two objects performed on the touchscreen.

The operation point obtaining sub-unit 622 is configured to obtain corresponding operation points on the touchscreen according to the final position of the at least one object at the end of the touch or approach action detected by the detecting sub-unit 621.

Specifically, when there are at least two objects touching or approaching the touchscreen, the detecting sub-unit 621 can detect the position of each of the at least two objects on the touchscreen. The operation point obtaining sub-unit 622 can obtain the corresponding operation points according to the final position of each object on the touchscreen at the end of the touch or approach action detected by the detecting sub-unit 621.

The area to capture determining unit 630 is configured to determine an area to capture in the terminal interface according to the operation points obtained by the operation point obtaining unit 620.

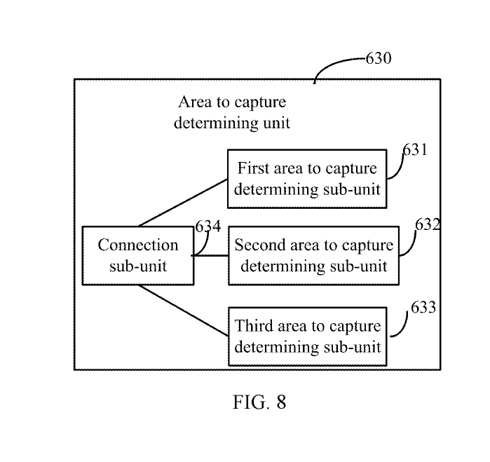

As used for an optional embodiment, if the operation point obtaining unit 620 obtains two operation points, as shown in FIG. 8, the area to capture determining unit 630 may further include the following.

A first area to capture determining sub-unit 631 is configured to determine an area to capture in the terminal interface according to a circle, an ellipse, or a rectangle formed by the two operation points obtained by the operation point obtaining unit 620.

Specifically, if the operation point obtaining unit 620 obtains two operation points on the touchscreen, the first area to capture determining unit 631 can determine an area to capture according to a circle formed by the two operation points. For example, the first area to capture determining sub-unit 631 can determine a straight line according to the two operation points, and determines a circle one symmetry axis of which is the straight line as an area to capture. For another example, the first area to capture determining sub-unit 631 can form a circle area the center of which is any of the two operation points and one point of which is another operation point, and determine the circle area as an area to capture. The first area to capture determining sub-unit 631 can further determine an elliptical area formed by the two operation points as an area to capture. For example, the first area to capture determining unit 631 can determine the two operation points as two ellipse focuses, and determine an elliptical area formed by the two ellipse focuses as an area to capture. The first area to capture determining sub-unit 631 can also determine a rectangular area formed by the two operation points as an area to capture. For example, the first area to capture determining sub-unit 631 can determine a rectangular area the diagonal line of which is the connection line formed by the two operation points as an area to capture.

As used for an optional embodiment, if the operation point obtaining unit 620 obtains at least three operation points, as shown in FIG. 8, the area to capture determining unit 630 may further include a second area to capture determining sub-unit 632 or a third area to capture determining sub-unit 633.

The second area to capture determining sub-unit 632 is configured to determine a polygon area vertexes of which are respectively the at least three operation points obtained by the operation point obtaining unit 620 and edges of which are respectively the connection lines each formed by two adjacent operation points of the at least three operation points as an area to capture.

The third area to capture determining sub-unit 633 is configured to determine a greatest operation area formed by the connection of the at least three operation points obtained by the operation point obtaining unit 620 as an area to capture.

Furthermore and optionally, the area to capture determining unit 630 can further include a connection sub-unit 634 respectively connected to the first area to capture determining sub-unit 631, a second area to capture determining sub-unit 632, and a third area to capture determining sub-unit 633, and is configured to trigger the corresponding area to capture determining sub-unit according to the obtained operation points obtained by the operation point obtaining unit 620 so as to determine an area to capture according to the operation points. The connection sub-unit 634 may be a common connection equipment.

The screenshot obtaining unit 640 is configured to store the image corresponding to the area to capture determined by the area to capture determining unit 630 as a capture image.

Specifically, the area to capture obtaining unit 640 can store the content displayed in the terminal interface and corresponding to the area to capture determined by the area to capture determining unit 630 as a screenshot.

Furthermore, the terminal may further include an area to capture adjusting unit 650 configured to adjust the area to capture according to operations performed by the user on the obtained operation points.

Specifically, after the area to capture determining unit 630 determines an area to capture in the terminal interface, the area to capture adjusting unit 650 can correspondingly adjust the area to capture according to operations performed by the user on any of or more of the operation points. For example, the area to capture determined by the area to capture determining unit 630 is shown in FIG. 3, the area to capture adjusting unit 650 can determine that the adjusted figure is shown in FIG. 4 according to user's adjusting operation performed on the operation point of D. Wherein, in FIG. 4 the figure formed by solid lines is the adjusted figure. The screenshot obtaining unit can store the image corresponding to the adjusted area to capture as a screenshot.

In the embodiments of the present invention, the area to capture determining unit can determine an area to capture in the terminal interface according to actions of at least two objects touching or approaching the touchscreen, and the screenshot obtaining unit can store the image corresponding to the area to capture as a screenshot, thus a screenshot needed by the user can be obtained according to operations performed by the user on the touchscreen, thereby improving user's experience.

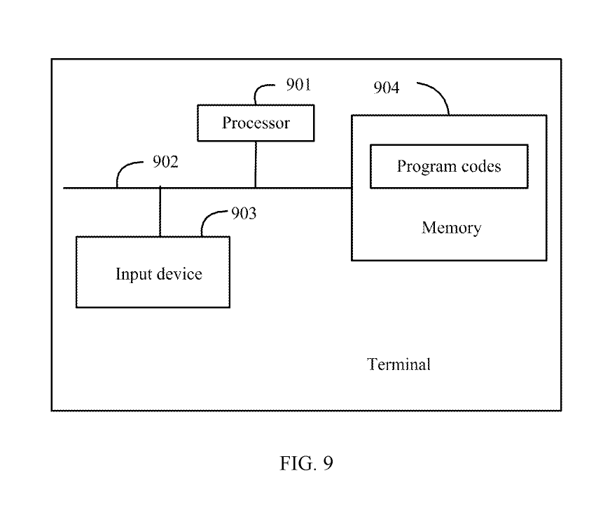

FIG. 9 is a schematic view of a structure of a terminal provided by another embodiment of the present invention. As shown in FIG. 9, the terminal includes at least one processor 901 (e.g., CPU), at least one communication bus 902, an input device 903, and a memory 904. The memory 904 can be a high speed RAM, or a non-volatile memory, such as at least one disc memory. The memory 904 can be at least one storage device away from the processor 901.

The communication bus 902 is configured to realize connection and communication among these assemblies.

The input device 903 is configured to obtain a screen capture instruction for capturing the terminal interface input by the user, and detect actions of at least two objects touching or approaching the terminal interface. Wherein, the input device 903 can be a touchscreen.

Furthermore, the input device 903 being configured to detect actions of at least two objects touching or approaching the terminal interface may be the following.

The input device 903 is configured to detect the touch or approach action of at least one of the at least two objects performed on the touchscreen.

The memory 904 stores a set of program code. The processor 901 invokes the program code stored in the memory 904 to execute the following operations.

An operation is to obtain corresponding operation points on the touchscreen according to the detected actions.

An operation is to determine an area to capture in the terminal interface according to the operation points.

An operation is to store the image corresponding to the area to capture as a screenshot.

In an optional embodiment, the processor 901 invoking the program code stored in the memory 904 to obtain the corresponding operation points on the touchscreen according to the detected actions may be the following.

The processor 901 invokes the program code to obtain the corresponding points on the touchscreen according to the final position of the at least two objects at the end of the touch or approach action.

Wherein, if two operation points are obtained, the processor 901 invoking the program code stored in the memory 904 to determine an area to capture in the terminal interface according to the operation points may be the following.

The processor 901 invokes the program code to determine an area to capture in the terminal interface according to a circle, an ellipse or a rectangle formed by the two operation points.

In an optional embodiment, if at least three operation points are obtained, the processor 901 invoking the program code stored in the memory 904 to determine an area to capture in the terminal interface according to the operation points may be the following.

The processor 901 invokes the program code to determine a polygon area vertexes of which are respectively the at least three operation points and edges of which are respectively the connection lines each formed by two adjacent operation points of the at least three operation points as an area to capture.

Or the processor 901 invokes the program code to determine a greatest operation area formed by connection of the at least three operation points as an area to capture.

In an optional embodiment, after the processor 901 invokes the program code stored in the memory 904 to determine an area to capture in the terminal interface according to the operation points, the processor 901 can further execute the following operations.

An operation is to adjust the area to capture according to operations performed by the user on the obtained operation points.

Furthermore, the processor 901 storing the image corresponding to the area to capture as a screenshot may include the following.

The processor 901 stores the image corresponding to the adjusted area to capture as a screenshot.

Specifically, the terminal illustrated in this embodiment can be used to implement a portion of or all of the procedures in embodiments of the method for capturing a screen illustrated according to FIG. 1 or FIG. 5.

One of ordinary skill in the art can understand that all or part of process can be accomplished by using a computer program to instruct related hardware. All the program can be stored in a computer-readable storage medium. When the program is executed, the process of the embodiments of the above-mentioned methods can be included. Wherein, the storage medium can be a magnetic disk, an optical disk, a ROM (Read-Only Memory, ROM), a RAM (Random Access Memory, RAM), or the like.

It needs to point out that in the above embodiments, descriptions of various embodiments focus differently. Associated descriptions in other embodiments can be referred to learn the part of some embodiment which is not described in detail. Secondly, those skilled in the art should also know that the embodiments described in this specification are all preferred embodiments, and actions and modules in these embodiments may not be necessary for this invention.

According to actual need, the order of the steps of the methods in the embodiments of the present invention can be adjusted, some steps can be merged into one step, and some step can be deleted.

According to actual need, some modules or units of the device in the embodiments of the present invention can be merged into one module or unit, some module or unit can be divided into several modules or units, and some module or unit can be deleted.

The modules or units in all embodiments of the present invention can be realized by a universal integrated circuit, such as a CPU (Central Processing unit, CPU) for example, or by an ASIC (Application Specific Integrated Circuit, ASIC).

The above specifically illustrates the method for capturing a screen of a terminal and the terminal provided by an embodiment of the present invention. The specification adopts specific cases to illustrate the principle and embodiments of the present invention. The illustration for the above embodiments are merely used to assist in understanding methods and core concept of the present invention. Also, for those skilled in the art, according to the concept of the present invention, there are variations in specific implementation and application ranges. As described above, it should understand that the specification is not limitation to the present invention.

1. A method for capturing a screen of a terminal, comprising:
obtaining a screen capture instruction for capturing a terminal interface input by a user;
detecting actions of at least two objects touching or approaching a touchscreen and obtaining corresponding operation points on the touchscreen according to the detected actions;
determining an area to capture in the terminal interface according to the operation points; and
storing the image corresponding to the area to capture as a screenshot.

2. The method of claim 1, wherein detecting actions of at least two objects touching or approaching a touchscreen and obtaining corresponding operation points on the touchscreen according to the detected actions comprises:
detecting an action of at least one of the at least two objects touching or approaching the touchscreen; and
obtaining the corresponding operation points on the touchscreen according to the final position of the at least one object at the end of the touch or approach action.

3. The method of claim 1, wherein if two operation points are obtained, determining the area to capture in the terminal interface according to the operation points comprises determining the area to capture according to a circle, an ellipse or a rectangle formed by the two operation points.

4. The method of claim 1, wherein if at least three operation points are obtained, determining the area to capture in the terminal interface according to the operation points comprises:
determining a polygon area vertexes of which are respectively the at least three operation points and edges of which are respectively the connection lines each formed by two adjacent operation points of the at least operation points as the area to capture;
or determining a greatest operation area formed by the connection of the at least three operation points as the area to capture.

5. The method of claim 1, wherein after determining the area to capture in the terminal interface according to the operation points, the method further comprises:
adjusting the area to capture according to operations performed by the user on the obtained operation points;
wherein storing the image corresponding to the area to capture as a screenshot comprises:
storing the image corresponding to the adjusted area to capture as a screenshot.

6. A terminal comprising:
a screen capture instruction obtaining unit configured to obtain a screen capture instruction for capturing a terminal interface input by a user;
an operation point obtaining unit configured to detect actions of at least two objects touching or approaching a touchscreen and obtain corresponding operation points on the touchscreen according to the detected actions;
an area to capture determining unit configured to determine an area to capture in the terminal interface according to the operation points; and
a screenshot obtaining unit configured to store the image corresponding to the area to capture as a screenshot.

7. The terminal of claim 6, wherein the operation point obtaining unit comprises a detecting sub-unit configured to detect an action of at least one of the at least two objects touching or approaching the touchscreen, and an operation point obtaining sub-unit configured to obtain corresponding operation points on the touchscreen according to the final position of the at least one object at the end of the touch or approach action.

8. The terminal of claim 6, wherein if the operation point obtaining unit obtains two operation points, the area to capture determining unit comprises a first area to capture determining sub-unit configured to determine the area to capture in the terminal interface according to a circle, an ellipse or a rectangle formed by the two operation points.

9. The terminal of claim 6, wherein if the operation point obtaining unit obtains at least three operation points, the area to capture determining unit comprises a second area to capture determining sub-unit configured to determine a polygon area vertexes of which are respectively the at least three operation points and edges of which are respectively the connection lines each formed by two adjacent operation points of the at least operation points as the area to capture, or a third area to capture determining sub-unit configured to determine a greatest operation area formed by the connection of the at least three operation points as the area to capture.

10. The terminal of claim 6, wherein the terminal further comprises an area to capture adjusting unit configured to adjust the area to capture according to operations performed by the user on the obtained operation points; the screenshot obtaining unit is configured to store the image corresponding to the adjusted area to capture as a screenshot.

11. A terminal comprising:
at least one communication bus configured to realize connection and communication among an input device, a memory, and a processor;
the input device configured to obtain a screen capture instruction for capturing a terminal interface input by a user and detect actions of at least two objects touching or approaching a touchscreen;
the memory storing a set of program code; and
the processor configured to invoke the set of program code stored in the memory to:
obtain corresponding operation points on the touchscreen according to the actions detected by the input device;
determine an area to capture in the terminal interface according to the operation points; and
store the image corresponding to the area to capture as a screenshot.

12. The terminal of claim 11, wherein the input device being configured to detect actions of at least two objects touching or approaching a touchscreen comprises:
detecting an action of at least one of the at least two objects touching or approaching the touchscreen;
the processor being configured to obtain corresponding operation points on the touchscreen according to the actions detected by the input device comprises:
obtaining the corresponding operation points on the touchscreen according to the final position of the at least one object at the end of the touch or approach action.

13. The terminal of claim 11, wherein if two operation points are obtained, the processor being configured to determine an area to capture in the terminal interface according to the operation points comprises:
determining the area to capture in the terminal interface according to a circle, an ellipse, or a rectangle formed by the two operation points.

14. The terminal of claim 11, wherein if at least three operation points are obtained, the processor being configured to determine the area to capture in the terminal interface according to the operation points comprises:
determining a polygon area vertexes of which are respectively the at least three operation points and edges of which are respectively the connection lines each formed by two adjacent operation points of the at least operation points as the area to capture:
or determining a greatest operation area formed by the connection of the at least three operation points as the area to capture.

15. The terminal of claim 11, wherein after the processor determines the area to capture in the terminal interface according to the operation points, the processor is further configured to adjust the area to capture according to operations performed by the user on the obtained operation points;
the processor being configured to store the image corresponding to the area to capture as a screenshot comprises:
storing the image corresponding to the adjusted area to capture as a screenshot.

16. The method of claim 2, wherein after determining the area to capture in the terminal interface according to the operation points, the method further comprises:
adjusting the area to capture according to operations performed by the user on the obtained operation points;
wherein storing the image corresponding to the area to capture as a screenshot comprises:
storing the image corresponding to the adjusted area to capture as a screenshot.

17. The terminal of claim 7, wherein the terminal further comprises an area to capture adjusting unit configured to adjust the area to capture according to operations performed by the user on the obtained operation points; the screenshot obtaining unit is configured to store the image corresponding to the adjusted area to capture as a screenshot.

18. The terminal of claim 12, wherein after the processor determines the area to capture in the terminal interface according to the operation points, the processor is further configured to adjust the area to capture according to operations performed by the user on the obtained operation points;
the processor being configured to store the image corresponding to the area to capture as a screenshot comprises:
storing the image corresponding to the adjusted area to capture as a screenshot.

19. The terminal of claim 13, wherein after the processor determines the area to capture in the terminal interface according to the operation points, the processor is further configured to adjust the area to capture according to operations performed by the user on the obtained operation points;
the processor being configured to store the image corresponding to the area to capture as a screenshot comprises:
storing the image corresponding to the adjusted area to capture as a screenshot.

20. The terminal of claim 14, wherein after the processor determines the area to capture in the terminal interface according to the operation points, the processor is further configured to adjust the area to capture according to operations performed by the user on the obtained operation points;
the processor being configured to store the image corresponding to the area to capture as a screenshot comprises:
storing the image corresponding to the adjusted area to capture as a screenshot
